(19) United States
(12) Patent Application Publication
(10) Pub. No.: US 2024/0256889 A1
(43) Pub. Date: Aug. 1, 2024

(54) METHOD AND APPARATUS FOR DEEP LEARNING

(71) Applicants: ROBERT BOSCH GMBH, Stuttgart (DE); TSINGHUA UNIVERSITY, Beijing (CN)

(72) Inventors: Hang Su, Beijing (CN); Jun Zhu, Beijing (CN); Tianyu Pang, Beijing (CN); Xiao Yang, Beijing (CN); Yinpeng Dong, Beijing (CN); Zhijie Deng, Beijing (CN); Ze Cheng, Shanghai (CN)

(21) Appl. No.: 18/565,510

(22) PCT Filed: May 31, 2021
(86) PCT No.: PCT/CN2021/097267

§ 371 Date: Nov. 29, 2023

(51) Int. Cl. G06N 3/094

(52) U.S. Cl. CPC G06N 3/094

(57) ABSTRACT

A method for deep learning. The method includes: receiving, by a deep learning model, a plurality of samples and a plurality of labels corresponding to the plurality of samples; adversarially augmenting, by the deep learning model, the plurality of samples based on a threat model; and assigning, by the deep learning model, a low predictive confidence to one or more adversarially augmented samples of the plurality of adversarially augmented samples having noisy labels due to the adversarially augmenting based on the threat model.

### FIELD

Aspects of the present disclosure relate generally to artificial intelligence or machine learning, and more particularly, to a method and an apparatus for deep learning.

### BACKGROUND

Deep neural networks (DNNs) have proved their effectiveness on a variety of domains and tasks. For example, DNNs are highly expressive models that have recently achieved state of the art performance on speech and visual recognition tasks. However, it has been found that DNNs are highly vulnerable to adversarial examples: adversarially perturbed examples that cause mis-classification while being nearly “imperceptible”, i.e., close to the original example. To enhance the robustness of DNNs against adversarial examples, adversarially training has proven to be among the most effective defense techniques, in which the network is trained on the adversarially augmented samples instead of on the natural or original ones.

However, a key problem of adversarially training is that, unlike in traditional deep learning, overfitting is a dominant phenomenon in adversarially training of deep networks. That is, adversarially training has the property that, after a certain point, further training will continue to substantially decrease the robust training loss, while increasing the robust test loss, witnessing a significant generalization gap. This failure on robust generalization may be surprising particularly since properly tuned DNNs (e.g., convolutional networks) rarely overfit much on standard vision datasets.

Many efforts have been devoted to studying robust generalization of adversarially training theoretically or empirically. In an aspect, some study results show that significantly increased sample complexity may be necessary for robust generalization, since robust generalization may require a more nuanced understanding of the data distribution than standard generalization. In another aspect, when the number of parameters is large, some theory suggests that some form of regularization is needed to ensure small generalization error.

It may be desirable to provide a method to mitigate robust overfitting and achieve better robustness.

### SUMMARY

The following presents a simplified summary of one or more aspects according to the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method for deep learning, comprising: receiving, by a deep learning model, a plurality of samples and a plurality of labels corresponding to the plurality of samples; adversarially augmenting, by the deep learning model, the plurality of samples based on a threat model; and assigning, by the deep learning model, a low predictive confidence to one or more adversarially augmented samples of the plurality of adversarially augmented samples having noisy labels due to the adversarially augmenting based on the threat model.

In another aspect of the disclosure, apparatus for deep learning comprises a memory; and at least one processor coupled to the memory. The at least one processor is configured to receive, by a deep learning model, a plurality of samples and a plurality of labels corresponding to the plurality of samples; adversarially augment, by the deep learning model, the plurality of samples based on a threat model; and assign, by the deep learning model, a low predictive confidence to one or more adversarially augmented samples of the plurality of adversarially augmented samples having noisy labels due to the adversarially augmenting based on the threat model.

In another aspect of the disclosure, a computer program product for deep learning comprises processor executable computer code for receiving, by a deep learning model, a plurality of samples and a plurality of labels corresponding to the plurality of samples; adversarially augmenting, by the deep learning model, the plurality of samples based on a threat model; and assigning, by the deep learning model, a low predictive confidence to one or more adversarially augmented samples of the plurality of adversarially augmented samples having noisy labels due to the adversarially augmenting based on the threat model.

In another aspect of the disclosure, a computer readable medium stores computer code for deep learning. The computer code when executed by a processor causes the processor to receive, by a deep learning model, a plurality of samples and a plurality of labels corresponding to the plurality of samples; adversarially augment, by the deep learning model, the plurality of samples based on a threat model; and assign, by the deep learning model, a low predictive confidence to one or more adversarially augmented samples of the plurality of adversarially augmented samples having noisy labels due to the adversarially augmenting based on the threat model.

To assign a relatively low predictive confidence for adversarially augmented samples having noisy labels in adversarially training, the presented method may leverage all training samples to suffice the need of sample complexity for adversarially training and hinder deep learning models from excessive memorization of one-hot labels in adversarially training.

Other aspects or variations of the disclosure, as well as other advantages thereof will become apparent by consideration of the following detailed description and accompanying drawings.

### BRIEF DESCRIPTION OF THE DRA WINGS

The disclosed aspects will hereinafter be described in connection with the appended drawings that are provided to illustrate and not to limit the disclosed aspects.

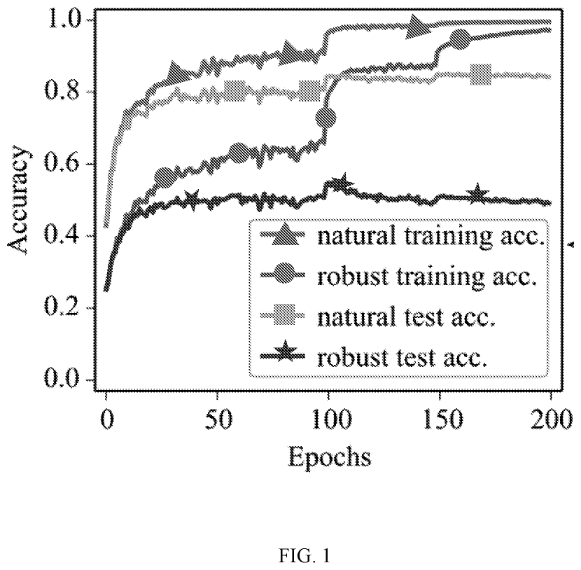

FIG. 1 shows an example of robust overfitting.

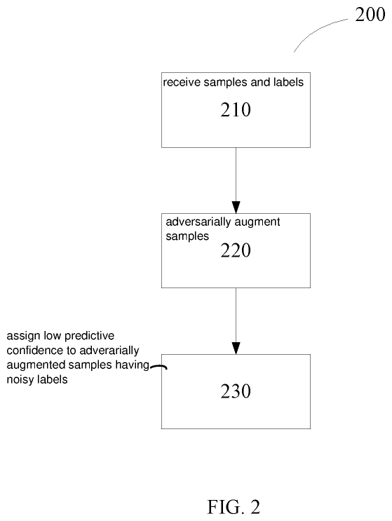

FIG. 2 illustrates an example flow diagram of method according to one or more aspects of the present disclosure.

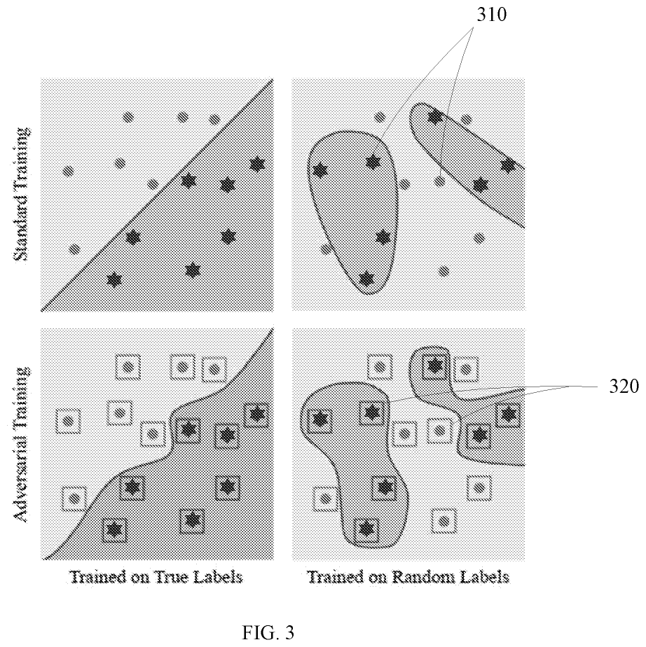

FIG. 3 shows a conceptual illustration of decision boundaries.

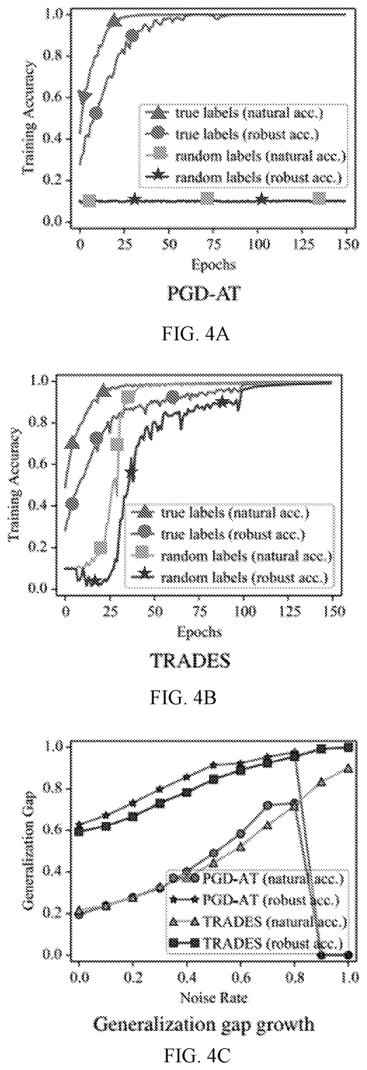

FIG. 4A and FIG. 4B show the natural and robust training accuracies of PGD-AT and TRADES, respectively, when trained on true or random labels, with explicit regularizations turned off.

FIG. 4C shows the generalization gap under varying levels of label noise from 0% (true labels) to 100% (completely random labels).

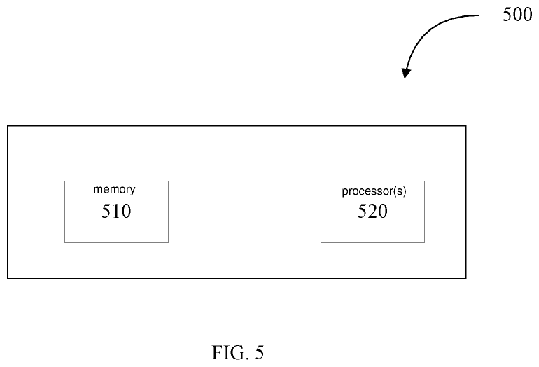

FIG. 5 illustrates an example of a hardware implementation for an apparatus according to one or more aspects of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Recent studies identify the robust overfitting phenomenon in adversarially training, i.e., shortly after the first learning rate decay, further training will continue to decrease the robust test accuracy. It further identifies that several remedies for overfitting, including explicit [symbol] ₁ and [symbol] ₂ regularization, data augmentation, etc., cannot gain improvements upon early stopping. Although robust overfitting has been thoroughly investigated, there may still lack an explanation of why it occurs. FIG. 1 shows an example of robust overfitting, where four accuracy curves of TRADES (TRadeoff-inspired Adversarial DEfense via Surrogate-loss minimization) on CIFAR-10 illustrate a standard generalization gap between natural training accuracy and natural test accuracy, and a robust generalization gap between robust training accuracy and robust test accuracy respectively. As shown in FIG. 1, after the first learning rate decay (e.g., around 100 epochs), further training will continue to increase the natural test accuracy, however to decrease the robust test accuracy steadily, witnessing growing robust generalization gap.

The present disclosure proposes a method for mitigating robust overfitting. The present disclosure identifies that the cause of robust overfitting of adversarially training may lie in memorization of one-hot labels. Some samples may naturally lie close to a decision boundary (e.g., may be referred to as “hard” samples hereafter), and should be assigned a low prediction confidence for the corresponding worst-case adversarially augmented samples relative to the samples that are located relatively far from the decision boundary (e.g., may be referred to as “easy” samples hereafter). Because it may be difficult for a network to assign one-hot labels for all perturbed samples within a perturbation budget, and labels can be inappropriate for some adversarially augmented samples that lie close to the decision boundary. In one aspect of the present disclosure, the true labels of some training samples may be noisy for adversarially training. As an example, the true one-hot labels of some training samples may become wrong labels when being attacked by augmenting some perturbations, particularly for the “hard” samples. As another example, after a certain epoch in training, a deep learning model may start to memorize these “hard” training samples with noisy labels, leading to a degeneration of test robustness.

To address this identified problem, the presented method for mitigating robust overfitting proposes to fit relatively “easy” samples with one-hot labels and assign a low predictive confidence for “hard” samples in adversarially training. The presented method may leverage all training samples to suffice the need of sample complexity for adversarially training and hinder deep learning models from excessive memorization of one-hot labels in adversarially training.

FIG. 2 illustrates an example flow diagram of method 200 according to one or more aspects of the present disclosure. Method 200 may be performed by a deep learning model. At block 210, a plurality of samples and a plurality of labels corresponding to the plurality of samples may be received by the deep learning model. In one aspect of the present disclosure, the plurality of samples and the plurality of labels corresponding to the plurality of samples may comprise a training dataset.

At block 220, the plurality of samples may be adversarially augmented by the deep learning model based on a threat model. In one aspect of the present disclosure, the deep learning model may comprise an adversarial defense method or model in deep learning under black-box attacks or white-box attacks.

At block 230, a low predictive confidence may be assigned by the deep learning model to one or more adversarially augmented samples of the plurality of adversarially augmented samples having noisy labels due to the adversarially augmenting based on the threat model. In one aspect of the present disclosure, after being adversarially augmented, “hard” samples may be assigned a low predictive confidence than “easy” samples.

As an example, the plurality of labels may comprise one-hot labels. As another example, the deep learning model may comprise one or more of projected gradient descent adversarial training (PGD-AT), or TRADES. As a further example, the threat model may comprise one or more of [symbol] ₂-norm threat model, or [symbol] _{∞}-norm threat model.

It will be appreciated by those skilled that other models or labels may be possible, and one or more additional steps may be included in the method 200.

FIG. 3 shows a conceptual illustration of decision boundaries. In order to illustrate the identified cause of robust overfitting and influences of “hard” samples and “easy” samples on adversarially training, the present disclosure proposes to consider models trained on random labels, in addition to true labels as usual. It is shown in FIG. 3 decision boundaries learned via standard training and adversarially training with true and random labels, respectively. As shown in FIG. 3, there may be a significantly more complicated decision boundary when training samples with random labels.

In order to illustrate potential behaviors of defense models under extreme condition, such as random labels, adversarially training is performing by PGD-AT and TRADES with random labels sampled uniformly over all classes. FIG. 4A, FIG. 4B, and FIG. 4C illustrate adversarially training with random labels on CIFAR-10. FIG. 4A and FIG. 4B show the natural and robust training accuracies of PGD-AT and TRADES, respectively, when trained on true or random labels, with explicit regularizations turned off. For both methods, the network achieves almost 100% natural and robust training accuracies when trained on true labels. When the labels are random, totally different behaviors are observed between PGD-AT and TRADES—PGD-AT fails to converge while TRADES still reaches nearly 100% training accuracies. FIG. 4C shows the generalization gap under varying levels of label noise from 0% (true labels) to 100% (completely random labels).

As shown in FIG. 4A and FIG. 4B, PGD-AT fails to converge and TRADES can converge under this circumstance. The latter may demonstrate that deep learning networks may have sufficient capacity to memorize adversarial samples of training dataset with completely random labels. Furthermore, the convergence issue of PGD-AT when trained on random labels may result from the intrinsic algorithm, i.e., adversarial loss function of PGD-AT.

PGD-AT formulates adversarial training as the following robust optimization problem:

$${min}_{θ} {\sum }_{i = 1}^{n} {max}_{{x}_{i}^{′} ∈ S ( {x}_{i} )} ϛ ( {f}_{θ} ( {x}_{i}^{′} ) , {y}_{i} ) \qquad Eq . ( 1 )$$

Where let D={(xᵢ, yᵢ)}ᵢ₌₁ⁿ denote a training dataset with n samples, where xᵢ∈R^{d} is a natural sample and yᵢ∈{1, . . . , C} is its true label often encoded as an one-hot vector 1_{y}_{ᵢ} with totally C classes. Where f_{θ} may be a DNN classifier with parameters θ that predicts probabilities over all classes, [symbol] is the classification loss (e.g., the cross-entropy loss as [symbol] (f_{θ}(x),y)=−1_{y}^{T} log f_{θ}(x)), and S(x)={x′:∥x′−x∥ₚ≤ϵ} is an adversarial region centered at x with radius ϵ>0 under the [symbol] ₚ-norm threat models (e.g., [symbol] ₂ and [symbol] _{∞} norms).

TRADES formulates adversarially training by minimizing a different adversarial loss:

$${min}_{θ} {\sum }_{i = 1}^{n} ϛ ( {f}_{θ} ( {x}_{i} ) , {y}_{i} ) + β \cdot {max}_{{x}_{i}^{′} ∈ S ( {x}_{i} )} 𝒟 ( {f}_{θ} ( {x}_{i} ) ‖ {f}_{θ} ( {x}_{i}^{′} ) ) \qquad Eq . ( 2 )$$

Where [symbol] is the classification loss (e.g., the cross-entropy loss), [symbol] is the Kullback-Leibler divergence, and β is a balancing hyperparameter.

In one aspect of the present disclosure, it is identified that TRADES in Eq. (2) may minimize a clean cross-entropy loss on natural samples, which may make DNNs memorize natural samples with random labels at first, before fitting adversarial samples. It can be seen from FIG. 4B that at the very early stage of TRADES training (e.g., the first 25 epochs), the natural accuracy starts to increase while the robust accuracy does not. But differently, PGD-AT in Eq. (1) directly minimizes the cross-entropy loss on adversarial samples with random labels, which could introduce unstable gradients with large variance, making it fail to converge.

Based on the analysis, the cross-entropy loss on natural samples may be added into the PGD-AT objective (e.g., Eq. (1)) to resemble the learning of TRADES with random labels, which may be written as:

$${min}_{θ} {\sum }_{i = 1}^{n} ( 1 - γ ) \cdot ϛ ( {f}_{θ} ( {x}_{i} ) , {y}_{i} ) + γ \cdot {max}_{{x}_{i}^{′} ∈ S ( {x}_{i} )} ϛ ( {f}_{θ} ( {x}_{i}^{′} ) , {y}_{i} ) \qquad Eq . ( 3 )$$

Where γ is gradually increased from 0 to 1.

By using the improved adversarial loss (i.e., Eq. (3)), the training on random labels can successfully converge. The improvement from Eq. (1) (failing to converge) to Eq. (3) (able to converge) may indicate that it may be beneficial to fit relatively “easy” samples with one-hot labels and assign a low predictive confidence for “hard” samples in adversarially training. In one aspect of the present disclosure, as shown in FIG. 3, in the two images of right column, relative to the natural samples (for example, as indicated by 310), the corresponding adversarially augmented samples (for example, as indicated by 320) may become closer to or even cross the decision boundary due to the attacking, which may result in noisy labels. Therefore, memorizing natural samples (that may be easier relative to corresponding adversarially augmented samples) with random labels at first, before fitting adversarial samples, as identified in Eq. (2) and utilized in Eq. (3), can improve the adversarially training even under extreme condition, such as random labels.

In one aspect of the present disclosure, the present disclosure identifies that several typical methods training models on the identified clean samples may be not suitable for adversarially training. Because these methods will neglect a portion of training data with noisy labels, which can lead to inferior results for adversarially training due to the reduction of sample complexity. In another aspect of the present disclosure, the present disclosure proposes to regularize the predictions of adversarial samples from being over-confident by integrating the temporal ensembling (TE) approach into the adversarial training frameworks. TE maintains an ensemble prediction of each data and penalizes the difference between the current prediction and the ensemble prediction. In further aspect of the present disclosure, the present disclosure identifies that TE is suitable for adversarially training since it enables to leverage all training samples and hinders the network from excessive memorization of one-hot labels with a regularization term.

In an example, by adding a regularization term of TE, the training objective of PGD-AT may be rewritten as:

$${min}_{θ} {\sum }_{i = 1}^{n} {max}_{{x}_{i}^{′} ∈ S ( {x}_{i} )} ϛ ( {f}_{θ} ( {x}_{i}^{′} ) , {y}_{i} ) + ω \cdot {‖ {f}_{θ} ( {x}_{i}^{′} ) - {\hat{P}}_{i} ‖}_{2}^{2} \qquad Eq . ( 4 )$$

Where ensemble prediction of a training sample xᵢ is denoted as Pᵢ, which is updated after each training epoch as Pᵢ←η·Pᵢ+(1−η)·f_{θ}(xᵢ), where η is the momentum term. Wherein \hat{P}ᵢ is the normalization of Pᵢ as a probability vector and ω is a balancing weight.

In another example, TE may be similarly integrated with TRADES with the same regularization term. With the regularization term, the deep learning model would learn to fit relatively “easy” samples with one-hot labels and assign low confidence for “hard” samples at initial. After the learning rate decays, the regularization term may avoid fitting one-hot labels for the “hard” samples. Therefore, the proposed algorithm may enable to learn under label noise in adversarially training and alleviate the robust overfitting problem.

It will be appreciated by those skilled that other algorithms may be possible to perform the method 200 described above with reference to FIG. 2.

To evaluate the performance of the proposed algorithm, experiment results are listed in Table 1. It is reported in Table 1 the test accuracy on the best checkpoint obtaining the highest robust accuracy under PGD-10 and the final checkpoint, as well as the difference between these two checkpoints. Besides PGD-10, PGD-1000, C&W-1000, AutoAttack and SPSA also be adopted for a more rigorous robustness evaluation. It can be observed that the difference between best and final test accuracies is reduce to around 1%. Due to the mitigation of robust overfitting, the proposed method or algorithm may achieve better robustness.

TABLE 1
Test accuracy (%) of several methods on CIFAR-10 under the [symbol] _{∞} norm with ϵ = 8/255 based on the ResNet-18 architecture.

| | Natural Accuracy | | | PGD-40 | | | PGD-1000 | | | C&W-1000 | | | AutoAttack | | | SPSA | | |
|---|---|---|---|---|---|---|---|---|---|---|---|---|---|---|---|---|---|---|
| Methods | Best | Final | Diff | Best | Final | Diff | Best | Final | Diff | Best | Final | Diff | Best | Final | Diff | Best | Final | Diff |
| PGD-AT | 83.75 | 84.82 | −1.07 | 52.64 | 44.92 | 7.72 | 51.22 | 42.74 | 8.48 | 50.11 | 43.63 | 7.48 | 47.74 | 41.84 | 5.90 | 53.51 | 47.48 | 6.03 |
| PGD-AT + TE | 82.35 | 82.79 | −0.44 | 55.79 | 54.83 | 0.96 | 54.65 | 53.30 | 1.35 | 52.30 | 51.73 | 0.57 | 50.59 | 49.62 | 0.97 | 55.11 | 54.87 | 0.24 |
| TRADES | 81.19 | 82.48 | −1.29 | 53.32 | 50.23 | 3.07 | 52.44 | 48.67 | 3.77 | 49.88 | 48.14 | 1.74 | 49.03 | 46.80 | 2.23 | 52.99 | 51.22 | 1.77 |
| TRADES + TE | 83.86 | 83.97 | −0.11 | 55.15 | 54.42 | 0.73 | 53.74 | 53.03 | 0.71 | 50.77 | 50.63 | 0.14 | 49.77 | 49.20 | 0.57 | 54.42 | 54.14 | 0.28 |

FIG. 5 illustrates an example of a hardware implementation for an apparatus 500 according to one or more aspects of the present disclosure. The apparatus 500 for deep learning may comprise a memory 510 and at least one processor 520. The processor 52 0 may be coupled to the memory 510 and configured to perform the method 200 described above with reference to FIG. 2 and one or more aspects of the present disclosure. The processor 520 may be a general-purpose processor, or may also be implemented as a combination of computing devices, e.g., a combination of a DSP and a microprocessor, multiple microprocessors, one or more microprocessors in conjunction with a DSP core, or any other such configuration. The memory 510 may store the input data, output data, data generated by processor 520, and/or instructions executed by processor 520.

The various operations, models, and networks described in connection with the disclosure herein may be implemented in hardware, software executed by a processor, firmware, or any combination thereof. According one or more aspects of the disclosure, a computer program product for deep learning may comprise processor executable computer code for performing the method 200 described above with reference to FIG. 2 and one or more aspects of the present disclosure. According to one or more aspects of the disclosure, a computer readable medium may store computer code for deep learning, the computer code when executed by a processor may cause the processor to perform the method 200 described above with reference to FIG. 2 and one or more aspects of the present disclosure. Computer-readable media includes both non-transitory computer storage media and communication media including any medium that facilitates transfer of a computer program from one place to another. Any connection may be properly termed as a computer-readable medium. Other embodiments and implementations are within the scope of the disclosure.

The method described in the present disclosure may be implemented by software, hardware, firmware, or any combination thereof, and may provide a machine learning model that is configured to perform one or more particular machine learning tasks. In one example, the machine learning tasks may include speech and visual recognition tasks. In another example, the machine learning tasks may be an agent control task carried out in a control system for automatic driving, a control system for an industrial facility, or the like.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the scope of the various embodiments. Thus, the claims are not intended to be limited to the embodiments shown herein but is to be accorded the widest scope consistent with the following claims and the principles and novel features disclosed herein.

1-11. (canceled)

12. A method for deep learning, comprising the following steps:
receiving, by a deep learning model, a plurality of samples and a plurality of labels corresponding to the plurality of samples;
adversarially augmenting, by the deep learning model, the plurality of samples based on a threat model; and
assigning, by the deep learning model, a low predictive confidence to one or more adversarially augmented samples of the plurality of adversarially augmented samples having noisy labels due to the adversarially augmenting based on the threat model.

13. The method of claim 12, wherein the plurality of labels include one-hot labels.

14. The method of claim 13, wherein the one or more adversarially augmented samples having noisy labels due to the adversarially augmenting based on the threat model are located closely to a decision boundary.

15. The method of claim 12, wherein the assigning of the low predictive confidence to the one or more adversarially augmented samples having noisy labels is performed by regularizing predictions of the plurality of adversarially augmented samples via temporal ensembling (TE).

16. The method of claim 15, wherein the deep learning model includes one or more of: (i) projected gradient descent adversarial training (PGD-AT), or (ii) TRadeoff-inspired Adversarial DEfense via Surrogate-loss minimization (TRADES).

17. The method of claim 12, wherein the threat model includes one or more of: (i) [symbol] ₂-norm threat model, or (ii) [symbol] _{∞}-norm threat model.

18. An apparatus for deep learning, comprising:
a memory; and
at least one processor coupled to the memory and configured to:
receive, by a deep learning model, a plurality of samples and a plurality of labels corresponding to the plurality of samples;
adversarially augment, by the deep learning model, the plurality of samples based on a threat model; and
assign, by the deep learning model, a low predictive confidence to one or more adversarially augmented samples of the plurality of adversarially augmented samples having noisy labels due to the adversarially augmenting based on the threat model.

19. A non-transitory computer readable medium on which is stored computer code for deep learning, the computer code when executed by a processor, causing the processor to perform the following steps:
receiving, by a deep learning model, a plurality of samples and a plurality of labels corresponding to the plurality of samples;
adversarially augmenting, by the deep learning model, the plurality of samples based on a threat model; and
assigning, by the deep learning model, a low predictive confidence to one or more adversarially augmented samples of the plurality of adversarially augmented samples having noisy labels due to the adversarially augmenting based on the threat model.

20. A method for visual recognition, comprising the following steps:
receiving, by a deep learning model, a plurality of samples and a plurality of labels corresponding to the plurality of samples, wherein the deep learning model is configured to perform a visual recognition task and the plurality of samples include a plurality of images;
adversarially augmenting, by the deep learning model, the plurality of samples based on a threat model; and
assigning, by the deep learning model, a low predictive confidence to one or more adversarially augmented samples of the plurality of adversarially augmented samples having noisy labels due to the adversarially augmenting based on the threat model.

21. The method of claim 20, wherein the plurality of samples and the plurality of labels corresponding to the plurality of samples include one or more of: (i) a CIFAR-10 training dataset, or (ii) a MNIST training dataset.
